(19) United States
(12) Patent Application Publication
(10) Pub. No.: US 2004/0170233 A1
(43) Pub. Date: Sep. 2, 2004

(54) Symbol normalization in MIMO systems

(76) Inventors: Eko N. Onggosanusi, Allen, TX (US); Srinath Hosur, Plano, TX (US); Anand G. Dabak, Plano, TX (US)

Correspondence Address: TEXAS INSTRUMENTS INCORPORATED, P O BOX 655474, M/S 3999, DALLAS, TX, 75265

(21) Appl. No.: 10/375,771

(22) Filed: Feb. 27, 2003

(51) Int. Cl. H04L 27/06

(52) U.S. Cl. 375/340

(57) ABSTRACT

A normalization for soft symbol estimates as reciprocal of the squared channel norm corresponding to each symbol.

### CROSS-REFERENCE TO RELATED APPLICATIONS

The following copending application discloses related subject matter and has a common assignee: application Ser. No. 10/144,114, filed May 13, 2002.

### BACKGROUND OF THE INVENTION

The present invention relates to communication systems, and more particularly to multiple-input multiple-output wireless systems.

Wireless communication systems typically use band-limited channels with time-varying (unknown) distortion and may have multi-users (such as multiple cellphone users within a cell). This leads to intersymbol interference and multi-user interference, and requires interference-resistant detection for systems which are interference limited. Interference-limited systems include multi-antenna systems with multi-stream or space-time coding which have spatial interference, multi-tone systems, TDMA systems having frequency selective channels with long impulse responses leading to intersymbol interference, CDMA systems with multi-user interference arising from loss of orthogonality of spreading codes, high data rate CDMA which in addition to multi-user interference also has intersymbol interference.

Interference-resistant detectors commonly invoke one of three types of equalization to combat the interference: maximum likelihood sequence estimation, (adaptive) linear filtering, and decision-feedback equalization. However, maximum likelihood sequence estimation has problems including impractically large computation complexity for systems with multiple transmit antennas and multiple receive antennas. Linear filtering equalization, such as linear zero-forcing and linear minimum square error equalization, has low computational complexity but has relatively poor performance due to excessive noise enhancement. And decision-feedback (iterative) detectors, such as iterative zero-forcing and iterative minimum mean square error, have moderate computational complexity but only moderate performance.

A wireless communications receiver may include a symbol detector which passes soft symbol estimates to a demodulator which, in turn, passes log likelihood ratios (LLRs) for coded bits to a (deinterleaver) sequence decoder, such as a Viterbi or Turbo decoder (iterative interleaved MAP decoders). Known interference-resistant symbol detectors have problems including complex normalization of soft outputs for use by decoders.

### SUMMARY OF THE INVENTION

The present invention provides a normalization for soft symbol estimates which includes a norm of the transmission channel from the symbol source without regard for the detection method.

The preferred embodiment normalization has advantages including simple computations.

### BRIEF DESCRIPTION OF THE DRAWINGS

FIG. 1 is a preferred embodiment flow diagram.

FIGS. 2a-2c show functional blocks of receivers and a transmitter.

FIGS. 3a-3b illustrate Turbo encoding and decoding.

FIGS. 4a-4d are simulation results.

### DETAILED DESCRIPTION OF THE PREFERRED EMBODIMENTS

1. Overview

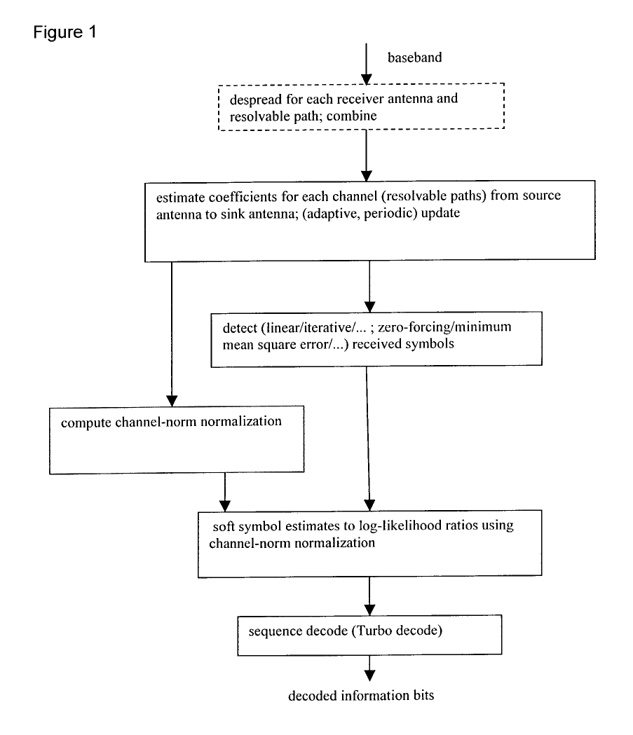

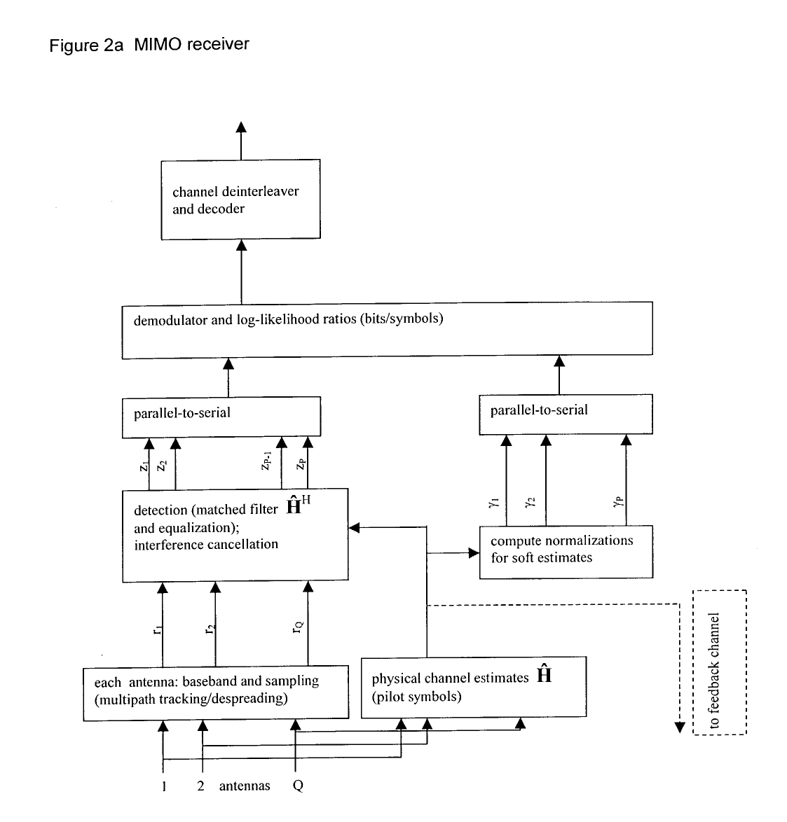

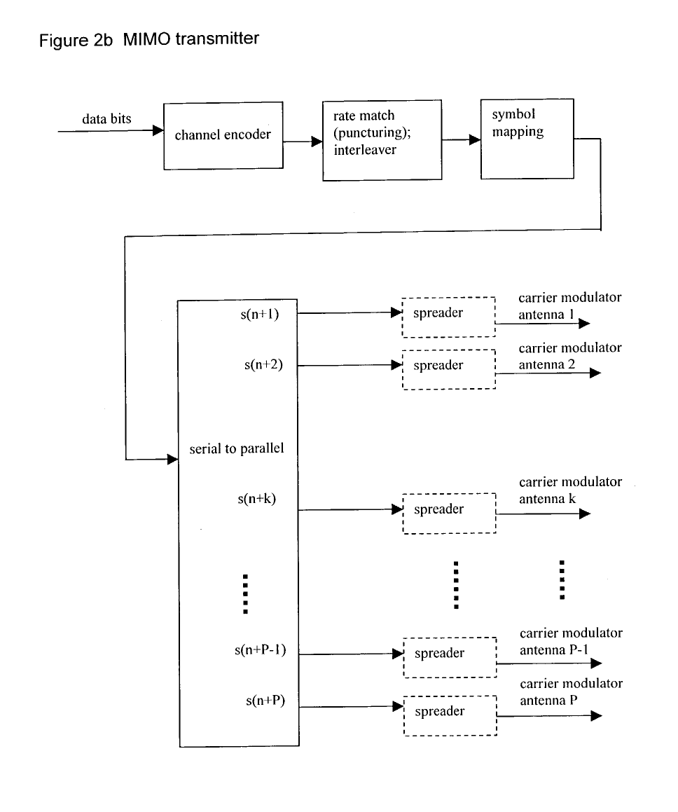

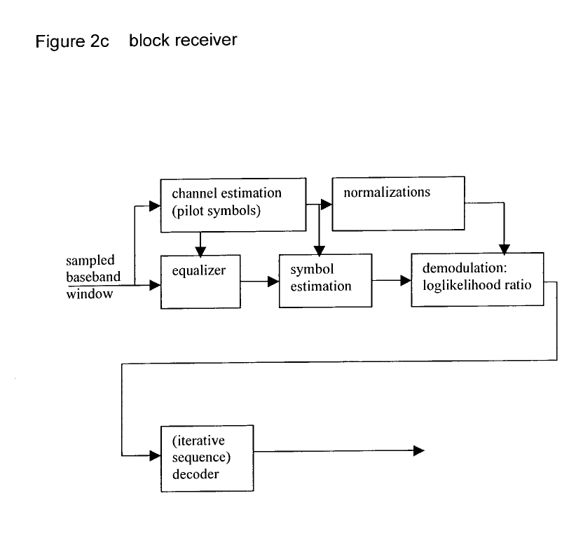

Preferred embodiment communication systems incorporate preferred embodiment detection methods which normalize soft symbol estimates using the reciprocal of the channel norm corresponding to the transmitted symbol. FIG. 1 is a flow diagram for a first preferred embodiment method. FIG. 2a shows functional blocks of a preferred embodiment receiver including a preferred embodiment normalization for a multi-input, multi-output (MIMO) wireless communications system.

Preferred embodiment wireless communications system components, base stations, and mobile users, could each include one or more application specific integrated circuits (ASICs), (programmable) digital signal processors (DSPs), and/or other programmable devices with stored programs for implementation of the preferred embodiment. The base stations and mobile users may also contain analog integrated circuits for amplification of inputs to or outputs from antennas and conversion between analog and digital; and these analog and processor circuits may be integrated on a single die. The stored programs may, for example, be in external or onboard ROM, flash EEPROM, and/or FeRAM. The antennas may be parts of RAKE detectors with multiple fingers for each user's signals. The DSP core could be a TMS320C6xxx or TMS320C5xxx from Texas Instruments.

2. Systems

FIG. 2a illustrates a preferred embodiment receiver with an interference-resistant detector plus preferred embodiment soft output normalization as could be used in a wireless communications system with P transmit antennas (P data streams) and Q receive antennas. FIG. 2b illustrates a corresponding transmitter with P transmit antennas. The received signal in such a system can be written as:

r=Hs+w

where r is the Q-vector of samples of the received baseband signal (complex numbers) corresponding to a transmission time n:

$$r = [ \begin{matrix}{r}_{1} ( n ) \\ {r}_{2} ( n ) \\ ⋮ \\ {r}_{Q} ( n )\end{matrix} ] ;$$

s is the P-vector of transmitted symbols (complex numbers of a symbol constellation) for time n:

$$s = [ \begin{matrix}{s}_{1} ( n ) \\ {s}_{2} ( n ) \\ ⋮ \\ {s}_{P} ( n )\end{matrix} ] ;$$

H is the Q×P channel matrix of attenuations and phase shifts; and w is a Q-vector of samples of received (white) noise. That is, the (q,p)th element of H is the channel (including multipath combining and equalization) from the pth transmit source to the qth receive sink, and the qth element of w is the noise seen at the qth receive sink.

Note that the foregoing relation applies generally to various systems with various interference problems and in which n, r, s, P, and Q have corresponding interpretations as in the following.

(i) Spatial interference: for a multi-input, multi-output (MIMO) system, Q is the number of receive antennas, P is the number of transmit antennas which also is the number of (interfering) data streams, n indexes time, and r and s are vectors of received samples and transmitted symbols. Q greater than or equal to P is needed to separate the P data streams. FIGS. 2a-2b illustrate possible receiver and transmitter.

(ii) Temporal interference: for temporal equalization with a single receive antenna, P is the number of transmitted symbols considered within one detection window and which interfere due to a non-ideal impulse response, Q is the number of detected samples for the window, n indexes the windows, and r and s are vectors of received samples and transmitted symbols. That is, P is essentially the number of symbols that are jointly detected (in a window) as they interfere with each other, and Q is the number of corresponding samples collected at the receiver. Q greater than or equal to P is needed to separate the P symbols. FIG. 2c shows a possible receiver including an equalizer.

(iii) Multi-user interference: for a CDMA system with K users, the receiver collecting samples at the chip rate (N_{c} chips per symbol), and detection windows of N symbols, Q equals NN_{c} times the number of receive antennas, P equals NK the number of symbols transmitted in the window, n indexes the detection window, and r and s are corresponding vectors of samples of received signals and transmitted symbols. Loss of orthogonality of spreading codes yields multi-user interference.

(iv) Combinations of foregoing interferences. For example, high-data-rate CDMA uses relatively short spreading codes and thus significant intersymbol interference (temporal interference) may occur along with multi-user interference.

A detector in a receiver as in FIG. 2a outputs soft estimates of transmitted symbols s to a demodulator and decoder. For linear filtering equalization detectors, such as linear zero-forcing (LZF) or linear minimum mean square error (LMMSE), the soft estimates, denoted by P-vector z, derive from the received signal by linear filtering with Q×P matrix F; namely, z=F r. For LZF with perfect estimation of the channel H the matrix F is given by:

F=[H^{H}H]⁻¹H^{H}

The channel estimation may derive from measurements on received pilot symbols or through a feedback channel. The channel estimation may be periodically updated to adapt to channel variations. Similarly, for LMMSE F is given by

F=[H^{H}H+σ²Λ⁻¹]⁻¹H^{H}

where Λ=E[ss^{H}] is the (diagonal) P×P matrix of expected symbol correlations:

$$Λ = [ \begin{matrix}{λ}_{1} & 0 & ⋯ & 0 \\ 0 & {λ}_{2} & ⋯ & 0 \\ ⋮ & ⋮ & ⋰ & ⋮ \\ 0 & 0 & ⋯ & {λ}_{P}\end{matrix} ]$$

Note F has the form of a product of an equalization matrix with H^{H} which is the matrix of the matched filter for the channel. Also, λₖ is the average energy of the kth symbol. In the case of LZF the equalization matrix is just the inverse of the product of the matched filter and the channel. Whereas, for LMMSE the equalization yields the minimum mean square error for estimating s, the P-vector of source symbols, from the received signal r; namely, F=arg min_{M} E∥Mr−s∥².

Iterative (decision-feedback) detectors, such as IZF and IMMSE, have a series of P linear detectors with each linear detector followed by a decision device and interference subtraction (cancellation). Each of the P linear detectors (iteration stages) outputs both a hard and a soft estimate of one of the P symbols. The hard estimate is used to regenerate the interference from the so-far estimated symbols which is then subtracted from the received signal, and the difference used for the next linear symbol estimation. More explicitly, presume the symbols are to be estimated in numerical order and let ŝₖ denote the hard estimate of the kth symbol sₖ and let the P-vector ŝ^{(k)} denote the vector with components 1, 2, . . . , k equal to ŝ₁, ŝ₂, . . . , ŝₖ, respectively, and with the remaining P−k components all equal to 0. The iteration's pth stage will output ŝ^{(p)} from an initialization of ŝ⁽⁰⁾=0. The pth stage (pth linear detector) proceeds as follows:

(a) Regenerate the interference created by previously-estimated symbols s₁, s₂, . . . , sₚ₋₁, using the (estimated) channel matrix: H ŝ^{(p-1)}. Note that only the first p−1 rows of H are used because the last P−p+1 components of ŝ^{(p-1)} equal 0, so a simpler matrix with rows p, p+1, . . . P all 0s could be used.

(b) Subtract the regenerated interference of step (a) from the received signal to have an interference-cancelled signal: r−H ŝ^{(p-1)}.

(c) Apply the linear detector filter F to the interference-cancelled signal from step (b) to generate a soft output z^{(p)} which estimates the yet-to-be-estimated symbols sₚ, sₚ₊₁, . . . , sₚ. Because the interference cancellation (decision feedback) likely is not perfect, further suppress the interfering symbols by use of a modified linear detector filter F^{(p)} which derives from the portion of the channel matrix from sources (antennas) p; p+1, . . . , P. That is, estimate z^{(p)}=F^{(p)}[r−H ŝ^{(p-1)}] where the matrix F^{(p)} ignores the portion of the channel relating to the previously-estimated symbols. The particular form of F^{(p)} depends upon the linear detector type and on assumption about the decision feedback error. In effect, the channel matrix is partitioned into two parts with the part relating to the previously-estimated symbols used to generate the interference estimate plus interference-cancelled signal and with the part relating to the yet-to-be-estimated symbols used for detection of the interference-cancelled signal.

(d) Make a hard decision on the pth component of the soft estimate z^{(p)} to generate the hard estimate ŝₚ and update the hard estimate vector ŝ^{(p)}. In particular, for assumed error-free decision feedback and IZF detection;

$${F}^{( p )} = [ \begin{matrix}{0}_{( p - 1 ) xQ} \\ {[ {A}_{p}^{H} {A}_{p} ]}^{- 1} {A}_{p}^{H}\end{matrix} ]$$

where Aₖ is the Q×(P−k+1) matrix of the last P−k+1 columns of (estimated) H; that is, Aₚ=[hₚ hₚ₊₁ . . . h_{P}] with hₖ the kth column of the channel matrix H. Of course, hₖ is the channel from the kth transmitted symbol to the Q-vector received.

Similarly for IMMSE

$${F}^{( p )} = [ \begin{matrix}{0}_{( p - 1 ) xQ} \\ {[ {A}_{p}^{H} {A}_{p} + {σ}^{2} {Λ}_{p}^{- 1} ]}^{- 1} {A}_{p}^{H}\end{matrix} ]$$

where Λₚ is the (P−k+1)×(P−k+1) diagonal submatrix of Λ with the elements λₚ, λₚ₊₁, . . . , λ_{P}.

Ordered detection based on the symbol post-detection SIRN is often used to reduce the effect of decision feedback error. Let the detection order be π(1), π(2), . . . , π(P) where π( ) is a permutation of the P integers {1, 2, . . . , P}; that is, the first estimated symbol (hard estimate output of the first stage of the iteration) will be ŝ_{π(1)} and the corresponding nonzero element of ŝ⁽¹⁾. The maximum SINR of the components of the first soft estimate z⁽¹⁾, which estimates all P symbols, determines π(1). Similarly, the SINRs of the components of z⁽²⁾, which estimates all of the symbols except s_{π(1)}, determines π(2), and so forth. The partitioning of the channel matrix at each stage is analogous.

The demodulator converts the soft symbol estimates z₁, z₂, . . . , z_{P} output by a detector (e.g., LZF, IZF, . . . ) into conditional probabilities; and the conditional probabilities translate into bit-level log likelihood ratios (LLRs) for (sequence) decoding. In more detail, the LLRs in terms of the bits uₚₖ which define the constellation symbols sₚ (e.g., two bits for a QPSK symbol, four bits for a 16QAM symbol, etc.) are defined as

$$\begin{matrix}LLR ( {u}_{p k} ) = log \{ P [ {u}_{p k} = 1 \vert {z}_{p k} ] / P [ {u}_{p k} = 0 \vert {z}_{p k} ] \} \\ = log \{ P [ {u}_{p k} = 1 \vert {z}_{p k} ] \} - log \{ P [ {u}_{p k} = 0 \vert {z}_{p k} ] \}\end{matrix}$$

The LLRs can be computed using a channel model. For example,

$$\begin{matrix}LLR ( {u}_{p k} ) = log \{ P [ {u}_{p k} = 1 \vert {z}_{p} ] / P [ {u}_{p k} = 0 \vert {z}_{p} ] \} \\ = log \{ P ( {z}_{p} \vert {u}_{p k} = 1 ) / p ( {z}_{p} \vert {u}_{p k} = 0 ) \} + \\ log \{ P [ {u}_{p k} = 1 ] / p [ {u}_{n k} = 0 ] \}\end{matrix}$$

where the first log term includes the probability distribution of the demodulated symbol zₚ which can be computed using the channel model. The second log term is the log of the ratio of a priori probabilities of the bit values and typically equals 0. So for an AWGN channel where the residual interference (interference which is not cancelled) is also a zero-mean, normally-distributed, independent random variable, the channel model gives:

p(zₚ|sₚ=c)˜exp(−|zₚ−c|²/γₚ)

where c is a symbol in the symbol constellation and γₚ is a normalization typically derived from the channel characteristics and the detector type. Indeed, the following section describes known normalizations and preferred embodiment normalizations. Of course, γₚ is just twice the variance of the estimation error random variable.

Then compute LLRs by using an approximation which allows direct application of the channel model. Take p(zₚ|uₚₖ=1)=p(zₚ|sₚ=cₚₖ₌₁) where cₚₖ₌₁ is the symbol in the sub-constellation of symbols with kth bit equal 1 and which is the closest to zₚ; that is, cₚₖ₌₁ minimizes |zₚ−cₖ₌₁|² for cₖ₌₁ a symbol in the sub-constellation with kth bit equal to 1. Analogously for p(zₚ|uₚₖ=0) using the sub-constellation of symbols with kth bit equal 0. Then with equal a priori probabilities of the bit values and the notation subscripts k=1 and k=0 indicating symbols with kth bits 1 and 0, respectively, the approximation yields

$$\begin{matrix}LLR ( {u}_{p k} ) = log \{ P ( {z}_{p} \vert {u}_{p k} = 1 ) / p ( {z}_{p} \vert {u}_{p k} = 0 ) \} \\ ≅ ( 1 / {γ}_{p} ) \{ min {\vert {z}_{p} - {c}_{k = 0} \vert}^{2} - min {\vert {z}_{p} - {c}_{k = 1} \vert}^{2} \}\end{matrix}$$

Thus the LLR computation just searches over the two symbol sub-constellations, {Cₖ₌₀} and {cₖ₌₁}, for the minima.

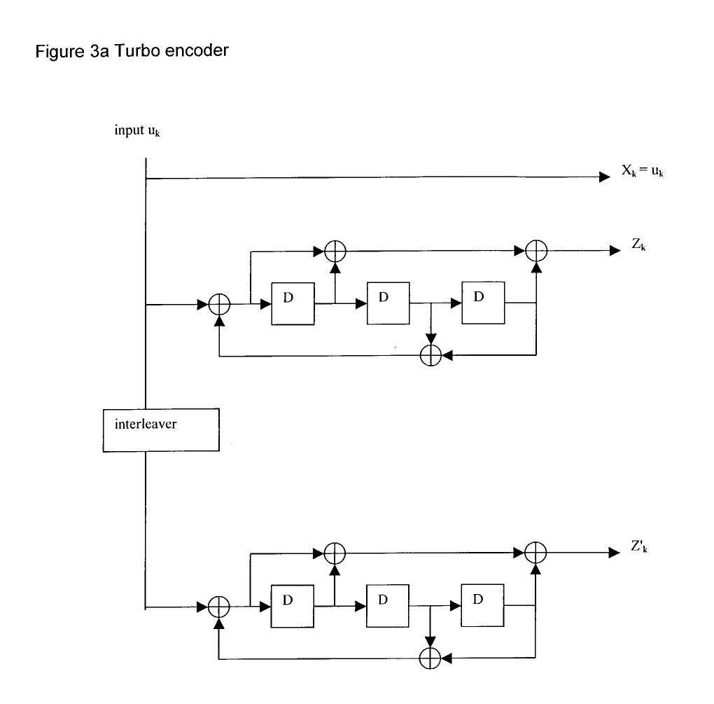

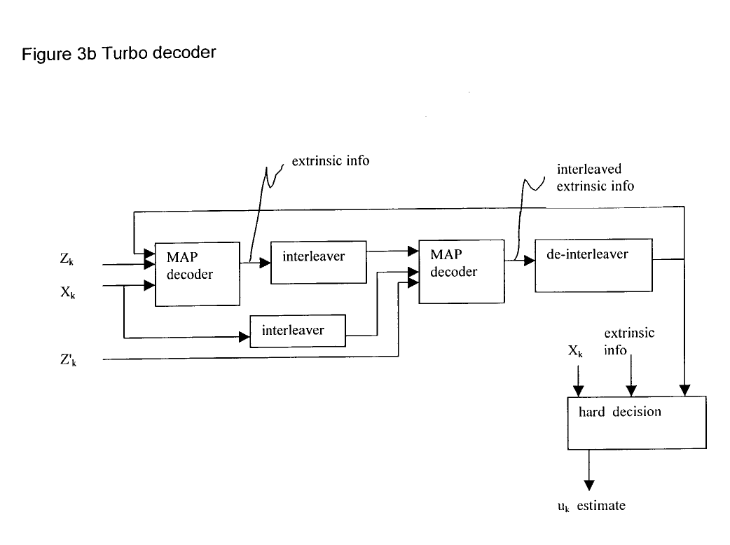

The LLRs are used in decoders for error correcting codes such as Turbo codes (e.g., iterative interleaved MAP decoders with BCJR or SOVA algorithm using LLRs for each MAP) and convolutional codes (e.g. Viterbi decoders). Such decoders require soft bit statistics (in terms of LLR) from the detector to achieve their maximum performance (hard bit statistics with Hamming instead of Euclidean metrics can also be used but result in approximately 3dB loss). Alternatively, direct symbol decoding with LLRs as the conditional probability minus the a priori probability could be used. FIGS. 3a-3b illustrate the 3GPP Turbo encoder and an iterative decoder which includes two MAP blocks, an interleaver, a de-interleaver, and feedback for iterations.

3. Normalization

The conditional probability evaluations for use in the decoder require an evaluation of the soft symbol estimate normalization γₚ. The preferred embodiment methods determine γₚ as a reciprocal of the norm of the Q-vector channel from the pth symbol source to the Q-sample sink receiver; that is, the pth column of H. This contrasts with known variance normalization methods for ZF and MMSE detectors which are as follows.

For LZF type detectors the natural choice of γₚ is the variance of the noise term associated with the soft estimate; that is, γₚ=var(nₚ) where zₚ=sₚ+nₚ. This relates to the AWGN noise power of the channel (σ²) and the corresponding (p,p) diagonal term of the matrix which amplifies the channel noise:

γₚ=σ²[H^{H}H]⁻¹_{p,p}

And for the iterative ZF detector (with numerical ordering) the analog applies:

γₚ=σ²[Aₚ^{H}Aₚ]⁻¹_{1,1}

where the (1,1) element corresponds to the channel from the pth symbol source due to the definition of Aₚ with first column equal hₚ.

For MMSE-type detectors a natural choice is to take γₚ as the mean square error:

γₚ=E[|zₚ−sₚ|²]

For LMMSE this translates to

γₚ=σ²[H^{H}H+σ²Λ⁻¹]⁻¹_{p,p}

and for the unordered iterative MMSE the analog obtains:

γₚ=σ²[Aₚ^{H}Aₚ+σ²Λₚ⁻¹]⁻¹_{1,1}

MMSE-type detectors can also use a variance type normalization.

Because MMSE detectors are biased in the sense that the mean of the estimation error, E[zₚ−sₚ], is not zero, the variance normalization becomes

γₚ=E[|zₚ−sₚ|²]−|E[zₚ−sₚ]|².

For linear MMSE this is

γₚ=σ²([H^{H}H+σ²Λ⁻¹]⁻¹H^{H}H[H^{H}H+σ²Λ⁻¹]⁻¹)_{p,p}

and for unordered iterative MMSE this is:

γₚ=σ²([Aₚ^{H}Aₚ+σ²Λₚ⁻¹]⁻¹Aₚ^{H}Aₚ[Aₚ^{H}Aₚ+σ²Λₚ⁻¹]⁻¹)_{1,1}

The bias of the MMSE detectors can be removed by applying a scaling factor to the soft outputs. This scaling factor does not affect post-detection SINR, yet results in increased mean square error compared to the regular biased MMSE estimate. While this unbiasing operation does not affect the performance of LMMSE detectors, it improves the performance of IMMSE detectors because the decision device that is used to generate decision feedback assumes unbiased soft output. The unbiasing operation for IMMSE detectors rescales the soft estimates as follows:

\check{z}ₚ=zₚ/([Aₚ^{H}Aₚ+σ²Λₚ⁻¹]⁻¹Aₚ^{H}Aₚ)_{1,1}

with \check{z}ₚ denoting the soft output after unbiasing. For unbiased IMMSE, variance-based and mean-squared-error-based normalizations are equivalent.

In each of the foregoing normalization methods (variance-based or mean-square-error-based) the normalization factor depends upon the detector type (ZF or MMSE, linear or iterative). In contrast, the first preferred embodiment normalization method avoids the use of the actual variance and instead takes

γₚ=σ²/(λₚ∥hₚ∥²) for p=1, 2, . . . , P

where ∥hₚ∥² is the square of the norm of the channel Q-vector hₚ, that is, the sum of the squared magnitudes of the Q components of the pth column of channel matrix H. FIG. 1 shows the overall flow. Thus, the first preferred embodiment normalization γₚ is not tied to a particular detector type; the same normalization can be used for ZF-type or biased/unbiased MMSE-type detectors as well as linear or iterative detectors. Compute ∥hₚ∥² from the estimated channel coefficients such as derived from pilot symbol measurements; λₚ is known from the transmitter; and σ² also may derive from pilot symbol measurements.

Because σ² is common to all symbols within a coding frame (block) and cancels out when the bit LLRs and decoder branch metrics are computed using the max-log approximation. In this case, the second preferred embodiment normalization omits σ². and takes

γₚ=1/(λₚ∥hₚ∥²) for p=1, 2, . . . , P

Further, if the mean energy is the same for all P symbol sources, then the λₚ term is also common and may be omitted when using the max-log approximation. In this case the normalization becomes simply 1/∥hₚ∥².

Note that for the ideal case of a diagonal H^{H}H (e.g., the sources and sinks are paired without interference), the inverse of H^{H}H is also diagonal, and the LZF normalization γₚ=σ²[H^{H}H]⁻¹_{p,p} equals the preferred embodiment normalization multiplied by the mean symbol energy λₚ. Indeed, the degenerate case of P=Q=1 has the normalization σ²/(λ∥h∥²)=N₀/(Eₛ∥h∥²).

Intuitively, for the MIMO case of P antennas transmitting P data streams to Q antennas (spatial interference), the preferred embodiments normalize zₚ with the reciprocal of the sum of squared attenuations of the Q channels from the pth transmit antenna, so large-attenuation channels have small normalization factors.

In contrast, for the case of a block of P transmitted symbols received as Q samples in a detection window and equalized (intersymbol interference), the preferred embodiments normalize zₚ with sum of squared magnitudes of the impulse response coefficients, and this normalization is the same for all zₚ from the detection window.

4. Simulation Results

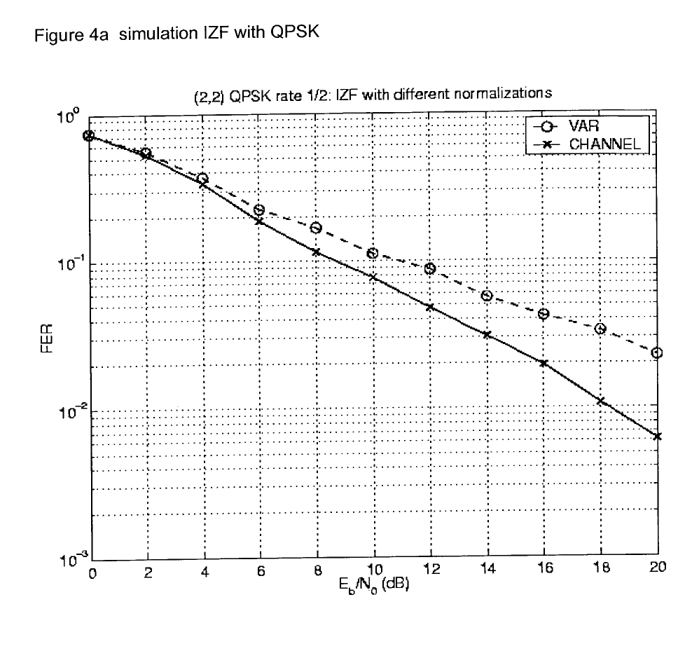

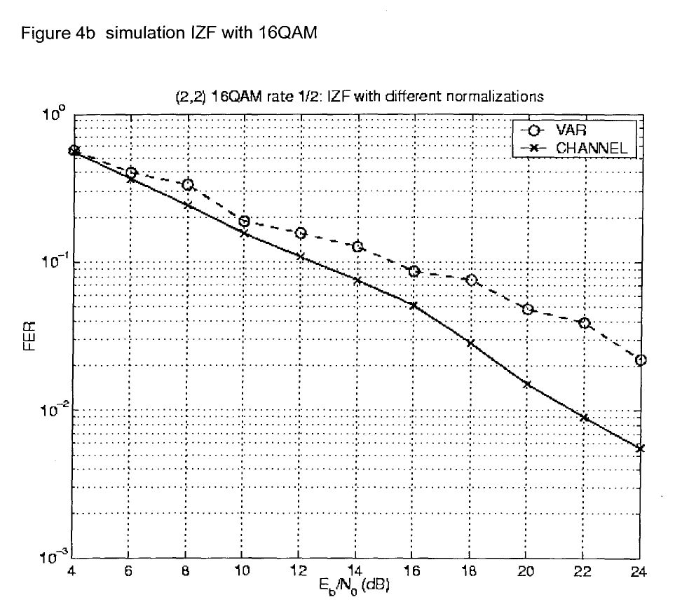

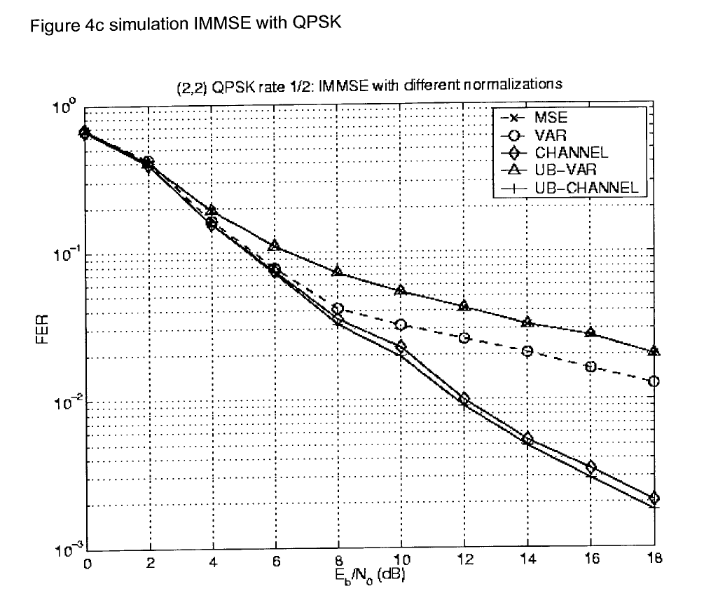

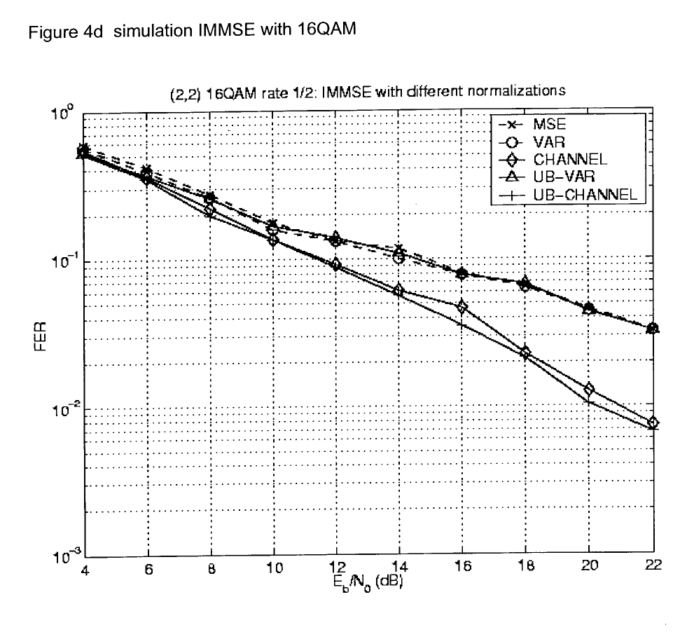

FIGS. 4a-4d show frame error rate (FER) vs. signal-to-noise ratio (E_{b}/N₀) simulations in an uncorrelated (IID) MIMO channel comparing various normalization methods, including preferred embodiments, for 2×2 MIMO with QPSK and 16QAM modulation using rate ½ Turbo coding and iterative zero-forcing (IZF) and IMMSE detectors.

FIGS. 4a-4b show the IZF detector with QPSK and 16QAM modulation, respectively, and with variance-based (VAR) and preferred embodiment channel-norm-based (CHANNEL) normalizations.

FIGS. 4c-4d show the IMMSE detector with QPSK and 16QAM modulation, respectively, and with variance-based without unbiasing (VAR), MSE-based without unbiasing (MSE), variance-based with unbiasing (UB-VAR), preferred embodiment channel-norm without unbiasing (CHANNEL), and preferred embodiment channel-norm with unbiasing (UB-CHANNEL) normalizations.

5. Modifications

The preferred embodiments may be varied while retaining one or more of the features of symbol estimate normalization using a norm of the channel from the symbol source.

What is claimed is:

1. A method of decoding, comprising:
(a) receiving through a transmission channel a signal encoding symbols s₁, s₂, . . . , sₚ where P is an integer greater than 1;
(b) finding estimates z₁, z₂, . . . , zₚ for said symbols s₁, s₂, . . . , sₚ, respectively, by detection using estimates of said communication channel;
(c) normalizing said estimates z₁, z₂, . . . , zₚ with factors γ₁, γ₂, . . . , γₚ, respectively, where γₖ depends upon an estimate of only the portion of said communications channel from a source of said symbol sₖ; and
(d) decoding said received signal using the results of step (c).

2. The method of claim 1, wherein:
(a) said transmission channel couples P source antennas with Q sink antennas where Q is a positive integer.

3. The method of claim 1, wherein:
(a) said detection is linear zero-forcing.

4. The method of claim 1, wherein:
(a) said detection is iterative zero-forcing.

5. The method of claim 1, wherein:
(a) said detection is linear minimum mean square error.

6. The method of claim 1, wherein:
(a) said detection is unbiased iterative minimum mean square error.

7. The method of claim 1, wherein:
(a) said detection is biased iterative minimum mean square error.

8. The method of claim 1, wherein:
(a) said encoding of step (a) of claim 1 includes turbo encoding; and
(b) said decoding of step (d) of claim 1 includes turbo decoding.

9. The method of claim 1, wherein:
(a) said γₖ equals σ²/(λₖ∥hₖ∥²) where σ² is an estimate of variance of the noise of the estimated portion of the communication channel from the source of symbol sₖ, λₖ is an estimate of the expectation of the energy of symbol sₖ, and ∥hₖ∥ is a norm of the estimated portion of the communication channel from the source of symbol sₖ.

10. The method of claim 1, wherein:
(a) said γₖ equals 1/(λₖ∥hₖ∥²) where λₖ is an estimate of the expectation of the energy of symbol sₖ, and ∥hₖ∥ is a norm of the estimated portion of the communication channel from the source of symbol sₖ.

11. The method of claim 1, wherein:
(a) said γₖ equals 1/∥hₖ∥² where ∥hₖ∥ is a norm of the estimated portion of the communication channel from the source of symbol sₖ.

12. A receiver, comprising:
(a) baseband sampler coupled to a transmission channel;
(b) a transmission channel estimator coupled to the output of said baseband sampler;
(c) a symbol detector coupled to said baseband sampler and to said transmission channel estimator, said detector with P symbol estimates z₁, z₂, . . . , zₚ output for a set of Q inputs from said baseband sampler where P and Q are integers greater than 1;
(d) a decoder with input coupled to said output of said symbol detector; and
(e) a symbol normalizer with input coupled to said transmission channel estimator and output coupled to said decoder with normalizations γ₁, γ₂, . . . , γₚ output corresponding to output symbol estimates z₁, z₂, . . . , zₚ, respectively, and where an output γₖ from said normalizer corresponding to a symbol estimate zₖ from said detector depends upon an estimate of only the portion of said transmission channel from a source of a symbol estimated by said symbol estimate zₖ.

13. The receiver of claim 12, wherein:
(a) said baseband sampler couples to Q antennas.

14. The receiver of claim 12, wherein:
(a) said baseband sampler couples to an equalizer with Q samples per detection window.
